(19) United States
(12) Patent Application Publication
(10) Pub. No.: US 2017/0087701 A1
(43) Pub. Date: Mar. 30, 2017

(54) ORIFICE PLATE CENTERING TOOL

(71) Applicant: Dieterich Standard, Inc, Boulder, CO (US)

(72) Inventor: Nathaniel K. Kenyon, Boulder, CO (US)

(21) Appl. No.: 15/270,093

(22) Filed: Sep. 20, 2016

Related U.S. Application Data
(60) Provisional application No. 62/233,623, filed on Sep. 28, 2015.

(51) Int. Cl. B25D 5/00; G01B 5/24; F16L 55/027

(52) U.S. Cl. CPC B25D 5/00; F16L 55/02754; G01B 5/24

(57) ABSTRACT

An orifice plate centering tool for use in centering an orifice plate includes a thin elongate member. A distal centering end is configured to contact the orifice plate. An opposed proximal end is configured to receive a force which is transferred to the distal centering end through the elongate member. A plurality of optional demarcations are provided along a length of the elongate member.

### CROSS-REFERENCE TO RELATED APPLICATION

The present application is based on and claims the benefit of U.S. provisional patent application Ser. No. 62/233,623, filed Sep. 28, 2015, the content of which is hereby incorporated by reference in its entirety.

### BACKGROUND

The present disclosure relates to orifice plates of the type used to create a pressure differential in a flow of process fluid. More specifically, the present disclosure relates to positioning such an orifice plate in process piping which carries the process fluid.

Methods that attempt to center the orifice plate in the pipe are either somewhat haphazard or expensive. The most reliable but expensive current method is to drill two carefully located holes in the mating flange(s) for two precision alignment pins to sit in. The orifice plate will then sit on the two alignment pins which locate it in the center of the pipe.

The much more practiced method involves putting the plate between the flanges using basic eyesight judgment to center it. The installer will move the flange studs to the furthest-from-center location in the bolt circle, and use a screwdriver or other “pseudo-gaging” device to feel how much of a gap is between each stud and the orifice plate. If the wiggle room the screwdriver or “gage” has between the orifice plate and each stud is not consistent, the installer will shift the orifice plate to a location where he or she feels the gage has the same wiggle room for each stud. This method is obviously open to much interpretation and is almost always not precise enough to meet the installation requirements of the applicable standard, the most common of which is ISO-5167-2.

ISO 5167-2 specifies how precisely the orifice plate needs to be centered to meet the stated accuracy of the plate in accordance with the standard. The permissible distance away from the pipe center the plate center can be is a function of pipe inner diameter and beta ratio. ISO 5167-2 specifies an off-center allowance in the direction parallel to the pressure taps.

As clarified in the two tables above, at larger betas and/or smaller line sizes the permissible off-center distance is truly impossible to gage by simply “eyeballing,” or by the typical quick and inaccurate methods that are often used during installations.

Many users of orifice plates are not knowledgeable of the very tight installation allowances in orifice plate standards such as ISO 5167-2. Some users do not mind that their orifice plates are most likely off-center because the cost of ensuring a good centering during installation is very high. Because of this, the method to center orifice plates must be inexpensive, extremely quick, and intuitive to learn.

### SUMMARY

An orifice plate centering tool for use in centering an orifice plate includes a thin elongate member. A distal centering end is configured to contact the orifice plate. An opposed proximal end is configured to receive a force which is transferred to the distal centering end through the elongate member. A plurality of optional demarcations are provided along a length of the elongate member.

### BRIEF DESCRIPTION OF THE DRAWINGS

FIG. 1 is a perspective view of one configuration of an orifice plate centering tool.

FIG. 2 is a close up view of a distal contacting end of the orifice plate centering tool of FIG. 1.

FIGS. 3-9 illustrate steps performed in centering an orifice plate using the orifice plate centering tool.

FIG. 10 is a perspective view of another example configuration of an orifice plate centering tool including a distal lip.

FIG. 11 is a side cross-sectional view showing the distal lip of FIG. 10 engaged with an orifice plate.

FIGS. 12-14 illustrate landing embodiments for an end of an orifice plate centering tool.

### DETAILED DESCRIPTION OF ILLUSTRATIVE EMBODIMENTS

There is an ongoing need for a reliable, inexpensive, and quick method of centering a paddle-style orifice plate within the pipe or flanges in which it is being installed.

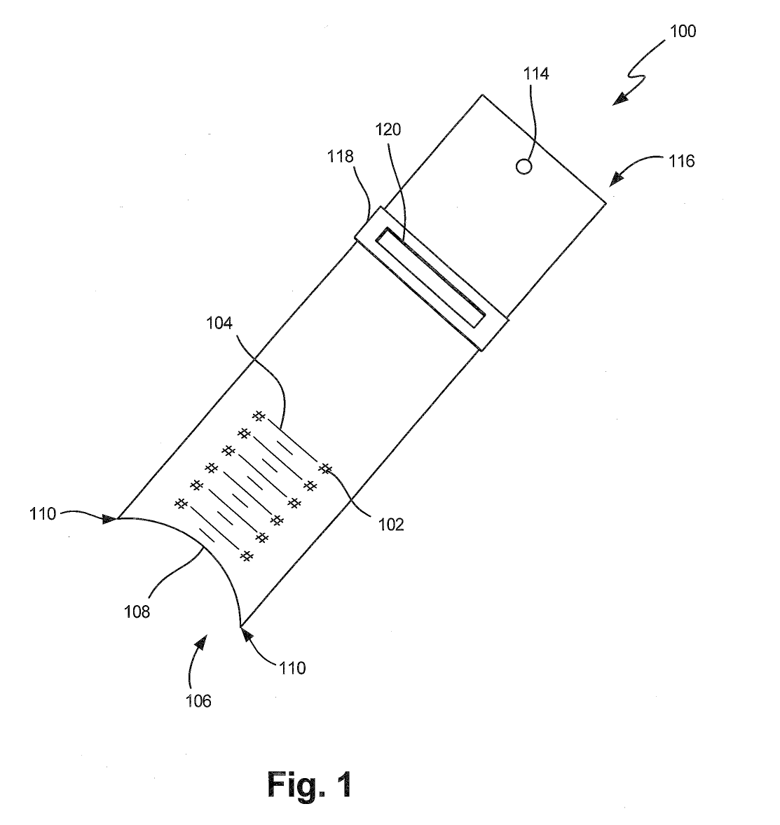

An orifice plate centering tool (or gage) 100 is shown in one embodiment in FIG. 1. The orifice plate centering gage 100 provides a convenient, simple, and quick method and apparatus for ensuring an orifice plate has been installed or placed in the center of a pipe instead of being offset to one direction or another. If an orifice plate or conditioning orifice plate is offset from the center of the pipe, measurement accuracy will be compromised. Currently, orifice plate users/installers do not have a reliable and inexpensive method of ensuring that the orifice plate in a pipe run is centered per the user's applicable orifice plate standard (for instance ISO 5167-2).

The orifice plate centering gage 100 can be used in one embodiment that meets these critical criteria. The orifice plate installer(s) or the individual(s) responsible for checking the installation of the orifice plate will use an orifice plate centering gage such as gage 100 to determine if the plate is centered, and if it is not centered, will immediately know how to adjust the plate so that it is centered.

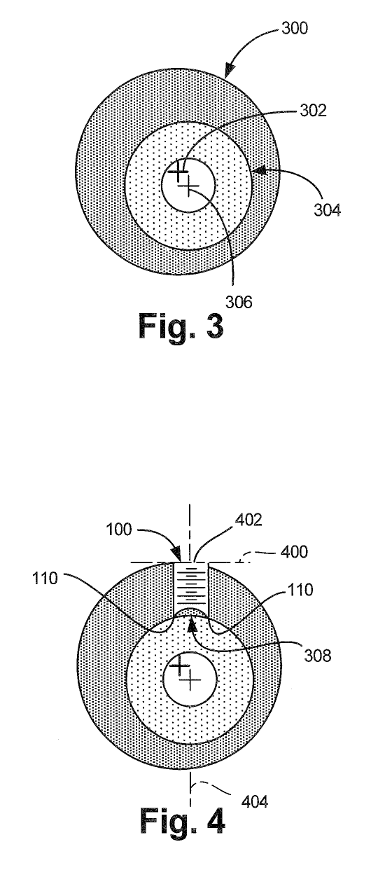

The tool 100 is in one embodiment a handheld gage roughly the size of a kitchen knife or ruler that is inserted between the orifice flanges/standard flanges/flange gaskets of an orifice plate installed in a pipe or the like until it is in contact with the orifice plate. The tool 100 has in one embodiment a constant thickness less than the thickness of an orifice plate but thick enough to be rigid under normal ergonomic loads. Accordingly, the tool 100 may be manufactured from a number of different materials without departing from the scope of the disclosure. In one embodiment, the tool 100 has a constant width large enough to contain gaging information, but small enough to be held comfortably. The tool 100 is long enough to contain gaging information pertinent to all sizes and flange ratings covered under ISO 5167-2 (or at least the most popular sizes of plates). In one embodiment, the edge 106 of the tool 100 which is to be placed against orifice plate includes a concave radius 108 so that when two protruding points 108 at the outer edge of the radius 108 at edge 106 contact edge of the orifice plate, the gaging information is substantially perpendicular to the orifice plate diameter. FIG. 1 shows one example configuration of the design of a tool 100. Use of the tool 100 is shown in greater detail in FIGS. 3-9.

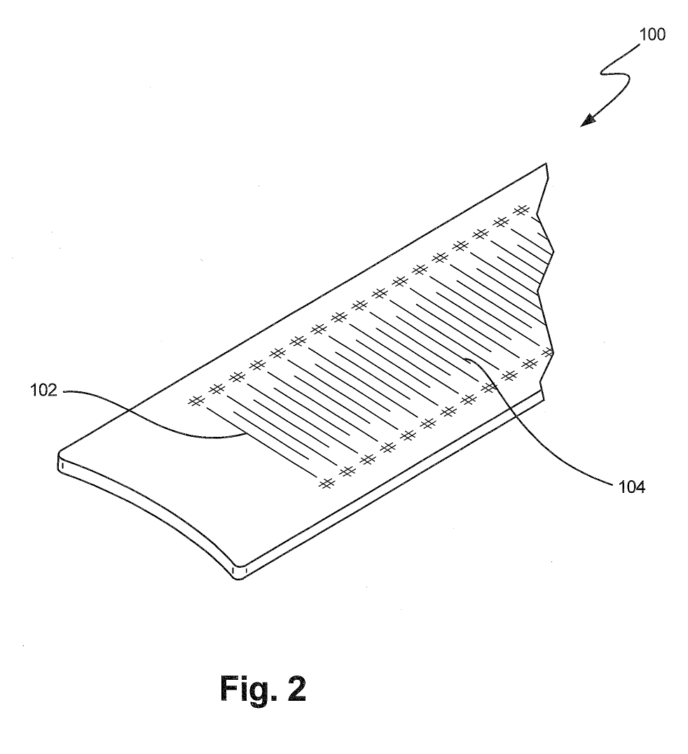

The gaging information includes in one embodiment gaging numbers 102 and gaging lines 104 (detailed in FIG. 2) must be legible, but in small enough increments that the total off-center amount measureable is within the relevant specification. To include an NPS 2 Schedule 40 pipe with a 0.65 beta orifice plate in the tool's measureable range, the demarcations must be 0.020 inches apart. If the tool were made specifically for larger line sizes, the demarcations could be further apart. This information could be marked on the tool with a laser, or attached to the tool with a sticker. In one embodiment, there are more gaging lines 104 than gaging numbers 102, and a user can interpret numbers associated with un-numbered lines.

FIG. 3 shows a cross section of a flange 300, which has a center 302, into which an orifice plate 304, which has a center 306, has been placed. The tool 100 is used in one embodiment in the following manner (further illustrated with respect to FIGS. 3-9): the installer places the orifice plate 304 as close to the center 302 of the flange 300 as he/she is capable of and then places the orifice plate centering tool 100 against a side 308 of the orifice plate 304 between the flanges (e.g., 300) and gaskets (not shown) in which it is installed. He/she then notes the location 400 (e.g., as determined by reading gage lines 102 and/or gage numbers 104) on the gage 100 at which the outermost point 402 of the upstream flange 300 reaches. The installer then places the tool 100 on the opposite side 312 of the orifice plate, and note the location 500 (e.g., as determined by reading gage lines 102 and/or gage numbers 104) on the gage 100 at which the outermost point 502 of the opposite side 312 of the upstream flange 300 is in contact with. The user then notes if the two sides 308, 312 of the orifice plate 300 are different distances away from the respective outside edge 402, 502 of the upstream flange 300. If the readings on the tool 100 are different for the measurements at the two opposite points on sides 308 and 312, the plate 304 is not centered. The user can then adjust the plate 304 such that it is centered along the axis that was measured, so that the tool 100 reads the same distance from the edge of the flange and the edge of the plate, or at least a close enough value to meet the appropriate centering specification. The user can then use the tool 100 along a different axis, such as one perpendicular to the first axis across the cross-section of the flange 300, until the orifice plate 304 is centered within the relevant specification. Once the plate 304 is centered, the tool 100 can be rotated around the edge of the orifice plate 304 and the tool gage reading can be confirmed across the entire circumference of the plate 304. Although upstream flanges are described with respect to the process described herein, it should be understood that downstream flanges could be used in the measurements and adjustments described herein without departing from the scope of the disclosure.

One embodiment of a method for which the tool 100 may be used is illustrated and further described in the section Example of a Standard Centering Using the Orifice Plate Centering Tool and FIGS. 3 through 8.

In another embodiment, an additional use for the tool 100 is as a mechanism to push an orifice plate such as plate 304 toward the pipe center. Once a reading or readings are taken and the amount and direction to adjust the plate 304 within a flange such as flange 300 or a pipe is determined, the orifice plate 304 may be pushed with the orifice plate centering tool 100, for example using a hammer. A standard hammer will not fit between two flange gaskets, and hammering a screw driver, such as a flat head screwdriver (which is often used) introduces a sharp tool that may harm the orifice plate outside edges, or slip off of the orifice plate 304 and potentially not only damage the orifice plate 304 outer edge, but also potentially other components of the orifice plate 304 and/or of flange 300. If the bolting between two flange gaskets that are mounted on either side of an orifice plate such as plate 304 are left finger tight, the orifice plate 304 location within the flanges and therefore a conduit may be adjusted in one embodiment by contacting the appropriate edge of the orifice plate 304 with the orifice plate centering tool 100 and hammering the tool 100 lightly with a rubber mallet or the like until the tool 100 displays a favorable gage reading (using gage numbers 102 and/or gage lines 104) indicating the plate 304 is centered. Once the plate 304 is initially centered, the tool 100 may be rotated around the circumference of the orifice plate 304 to verify the centering at various points on the outer edge of the orifice plate 304.

The concave radius 108 allows the tool 100 to be stably positioned on an outer edge of the orifice plate 304, as opposed to a flat head screwdriver or the like, where the radius 108 and the points 110 assist in preventing the tool 100 from slipping or being driven off of the orifice plate 304 during an adjustment using a hammer or the like. The radius 108 is sized such that an orifice plate 304 for which the tool 100 is to be used will be contacted by each of the points 110. This sizing assures that the gaging information is substantially perpendicular to the orifice plate diameter. Still further, the tool 100 remains in place on the orifice plate allowing a user to see the progress of the movement of the orifice plate with each tap of a hammer or the like, instead of having to stop, re-measure, and start again. In one embodiment, the tool 100 is constructed of a material sufficiently rigid and strong that it does not significantly deform when an adjustment of the position of the orifice plate 304 is made using the tool 100 and a hammer or the like to move the orifice plate 304 within the pipe or conduit in which it is mounted. In one embodiment, the points 110 themselves have a radius to prevent wear of the points if they were sharp.

The tool 100 may be used when installing a new orifice plate, or to verify the installation of previously installed orifice plates. The tool 100 may be provided as a stand-alone option, or as an addition to orifice plate/conditioning orifice plate orders.

Example of a Standard Centering Using the Orifice Plate Centering Tool Situation: In FIGS. 3-9, one example of centering an orifice plate 304 in a flange 300 is shown. In FIG. 3, the orifice plate 304 is either installed off-center or initially positioned off-center during installation with respect to the flange 300.

Step 1 (FIG. 4): Contact the edge 308 of the orifice plate 304 with the protruding two points 110 on the orifice plate centering tool 100. Use the orifice plate centering tool 100 gaging 102, 104 to take a reading 400 of the measurement at outside edge 402 of the upstream flange 300 at one location on the orifice plate 304.

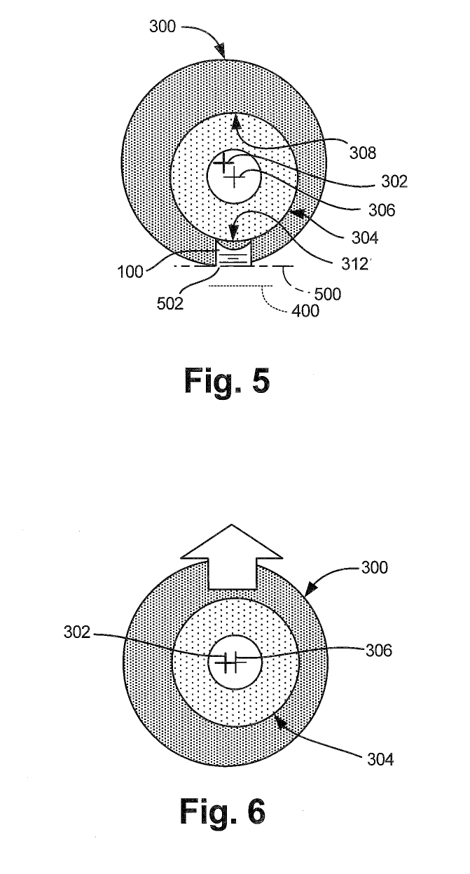

Step 2 (FIG. 5): Contact the opposite edge 312 of the orifice plate 304 (along an axis 404) with the two protruding points 110 on the orifice plate centering tool 100. Use the orifice plate centering tool 100 gaging 102, 104 to take a reading 500 of the measurement at outside edge 502, opposite edge 402, of the upstream flange 300 at the opposite location on the orifice plate 304.

Step 3 (FIG. 6): Using the first measurement reading 400 and the second measurement reading 500, the amount of half of the difference between the two gage readings 400 and 500 is how off-center the orifice plate 304 is in the direction that was measured (along axis 404). The smaller value of the readings 400, 500 is the edge of the orifice plate 304 that is closest to the edge of the flange 300 along axis 404, and it is this edge which is used to adjust the orifice plate 304 toward the center of the flange 300. This is accomplished by determining the gage reading that is halfway between the first gage reading 400 and the second gage reading 500. Depending on this value, along with line size and beta, the orifice plate 304 may not need to be adjusted. However, if the amount the orifice plate 304 is off-center in this direction is greater than the allowed amount per the appropriate standard, the orifice plate 304 should be adjusted toward the center 306 of the flange 300. The amount to move the orifice plate 304 is equal to the distance off-center the orifice plate 304 is. With the flanges tight enough to support the orifice plate 304 but not too tight to restrict the plate's motion, the orifice plate 304 may be moved by lightly hitting the orifice plate centering tool 100 with a hammer until the tool 100 displays a centered reading. The plate location may also be adjusted manually.

Example: if the first gage reading is 1.000 and the second gage reading is 1.060, the plate is 0.030 inches off-center in the direction of the lowest measurement, and the tool 100 is placed against the orifice plate 304 at the edge of the first gage reading, and is adjusted until the gage reading is 1.030.

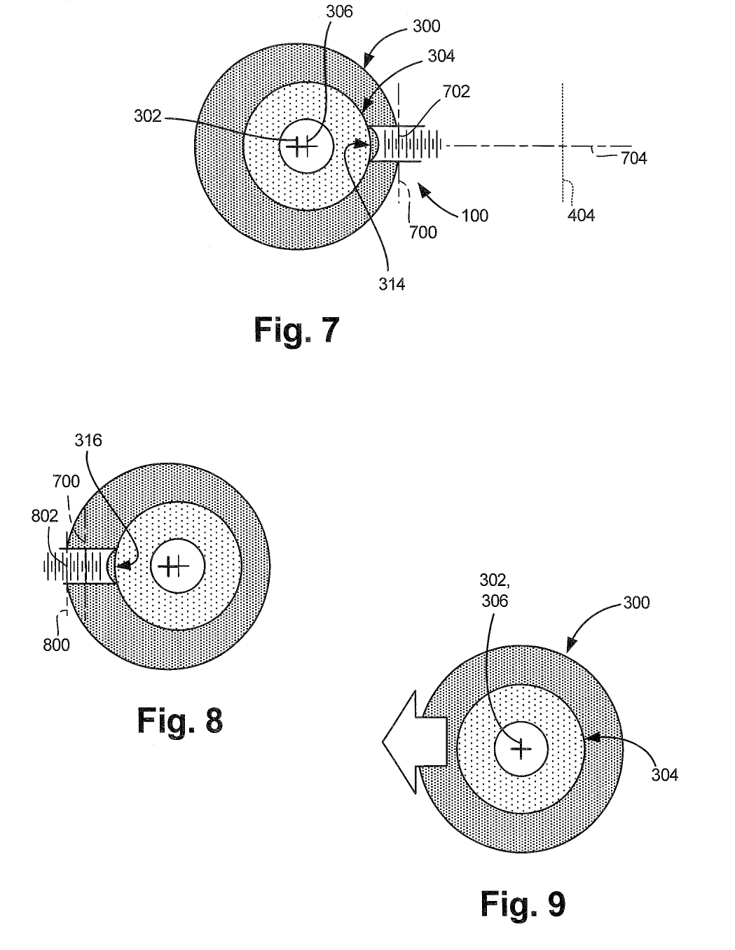

Step 4 (FIG. 7): Contact the edge 314 of the orifice plate 304 with the two protruding points 110 on the orifice plate centering tool 100 at a perpendicular axis 704 to the original centering direction axis 404. For instance, if the original centering was done in the vertical direction along axis 404, the second centering should take place in the horizontal direction along axis 704. Use the orifice plate centering tool 100 gaging 102, 104 to take a reading 700 of the measurement at outside edge 702 of the upstream flange 300 at that location on the orifice plate 304.

Step 5 (FIG. 8): Contact the opposite edge 316 of the orifice plate 304 with the two protruding points 110 on the orifice plate centering tool 100. Use the orifice plate centering tool 100 gaging 102, 104 to take a reading 800 of the measurement at outside edge 802, opposite edge 702, of the upstream flange 300 at the opposite location on the orifice plate 304.

Step 6 (FIG. 9): Using the first measurement reading 700 and the second measurement reading 800, the amount of half of the difference between the two gage readings 700 and 800 is how off-center the orifice plate 304 is in the direction that was measured (along, axis 704). The smaller value of the readings 700, 800 is the edge of the orifice plate 304 that is closest to the edge of the flange 300 along axis 704, and it is this edge which is used to adjust the orifice plate 304 toward the center of the flange 300. This is accomplished by determining the gage reading that is halfway between the first gage reading 700 and the second gage reading 800. Depending on this value, along with line size and beta, the orifice plate 304 may not need to be adjusted. However, if the amount the orifice plate 304 is off-center in this direction is greater than the allowed amount per the appropriate standard, the orifice plate 304 should be adjusted toward the center 306 of the flange 300. The amount to move the orifice plate 304 is equal to the distance off-center the orifice plate 304 is.

After the second adjustment of FIGS. 7-9, the orifice plate 304 will be centered appropriately on center 306 of flange 300. To confirm this, the orifice plate centering tool 100 can be used to take a reading along multiple points on the edge of the orifice plate 304 across its entire circumference. The readings should be consistent enough to match the applicable standard.

In various aspects, embodiments of the orifice plate centering tool 100 provide at least the following:
The orifice plate centering tool 100 is a tool used to measure how off-center an orifice plate is between two flanges that serve to center the orifice plate in a pipe or conduit.
The orifice plate centering tool 100 is thinner than an orifice plate but thick enough to not significantly deform under normal ergonomic loads.
The orifice plate centering tool 100 has demarcations of a value large enough to be legible but small enough to cover the required off-center allowances stated in the applicable standards.
The orifice plate centering tool 100 has a concave radius machined into the tool edge which comes into contact with the orifice plate edge to maintain a perpendicular alignment to the diameter of the orifice plate. The radius is of such a dimension that any orifice plate which the tool will be used on will be in contact with the two protruding points on either end of the radius.
The protruding points 110 on either end of the radius 108 have radiuses themselves to prevent the fast wear that would occur on sharp points in contact with an orifice plate.
The orifice plate centering tool 100 uses the outside of a mating flange in relation to the outside of the orifice plate to determine the amount off-center the plate is.
The orifice plate centering tool 100 may be provided with a hole 114 on the opposite end 116 of the tool 100 as the concave radius 108 to be used for hanging the tool 100 on a tool rack, belt clip, or a pegboard.
The orifice plate centering tool 100 may be used as a “punch” providing a mechanism to hammer the orifice plate into the centered location.

In one embodiment, the orifice plate centering tool 100 includes a sliding piece 118 which slidably engages the body of the tool 100 and is positionable to rest on the outside of the flange 300, and indicates (either physically or digitally) what the value of the distance between the outside edge of the flange 300 and the edge of the orifice plate 304 is, much like the sliding component of a caliper.

In one embodiment, circuitry is added to this sliding piece 118 (similar to a digital caliper), and a “zero” is incorporated into the interface which could be used for the first reading (such as reading 400 or reading 700 discussed herein). Further, an automatic off-center amount calculation may be performed by the circuitry after the second reading (such as reading 500 or reading 800 discussed herein) on the opposite side of the orifice plate 304 is taken, and a display 120 used to display the off-center calculation, indicate a direction of adjustment for the orifice plate 304, or the like. Orifice plate centering tools 100 may be customized to have demarcations specific to certain line sizes and flange ratings, instead of covering multiple scenarios. The gaging information 102, 104 which is printed on the tool 100 may take a number of forms and scales, not just inches away from the diameter as shown in FIGS. 1 and 2 above. Other options include but are not limited to millimeters or arbitrary demarcations at intervals appropriate to the standard used (for instance letters, letters with numbers, symbols, or colored ranges corresponding to flange sizes/ratings).

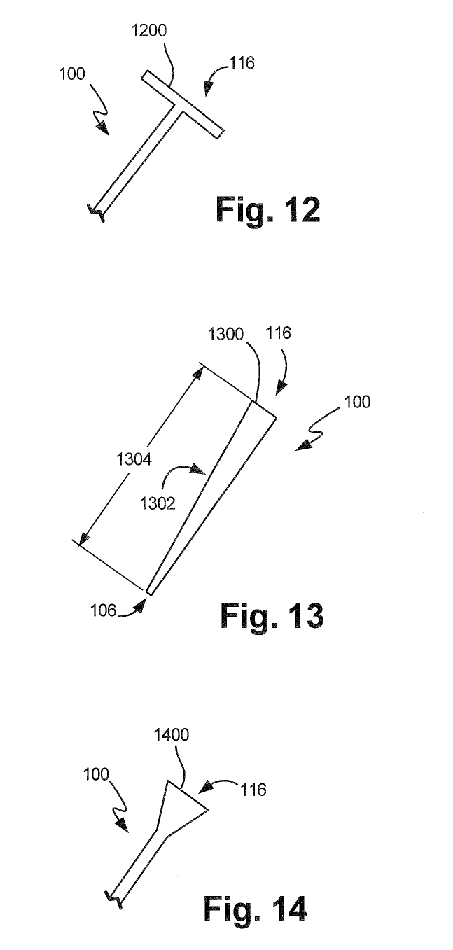

In various embodiments as shown in FIGS. 12-14, a “landing,” or feature of increased area, is added to the end 116 of the tool 100 opposite of the concave radius 108 to give a hammer or rubber mallet a larger target to hit when using the tool 100 as a punch between an orifice plate such as orifice plate 304 and a hammer. This feature may be achieved by welding on or otherwise forming a perpendicular plate landing 1200 to the far side of the tool as shown in cross section in FIG. 12; by giving the tool 100 a landing 1300 using a taper 1302 along a length 1304 of the tool 100 with a narrow end 106 being the end with the radius 108, and a wider end 116 as the end of the tool 100 opposite the radius 108 (FIG. 13); or by providing a flared end 1400 at end 116 of the tool 100 opposite the radius 108 (FIG. 14). The orifice plate tool 100 (or the “points” 110 of the concave radius 108 of the tool 100, or the landings 1200, 1300, 1400) may be made of hardened material such that it does not deform when hit with a hammer.

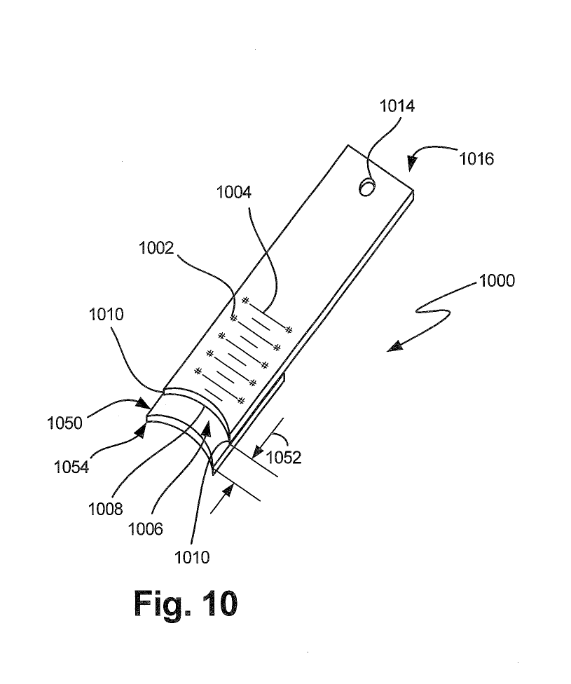

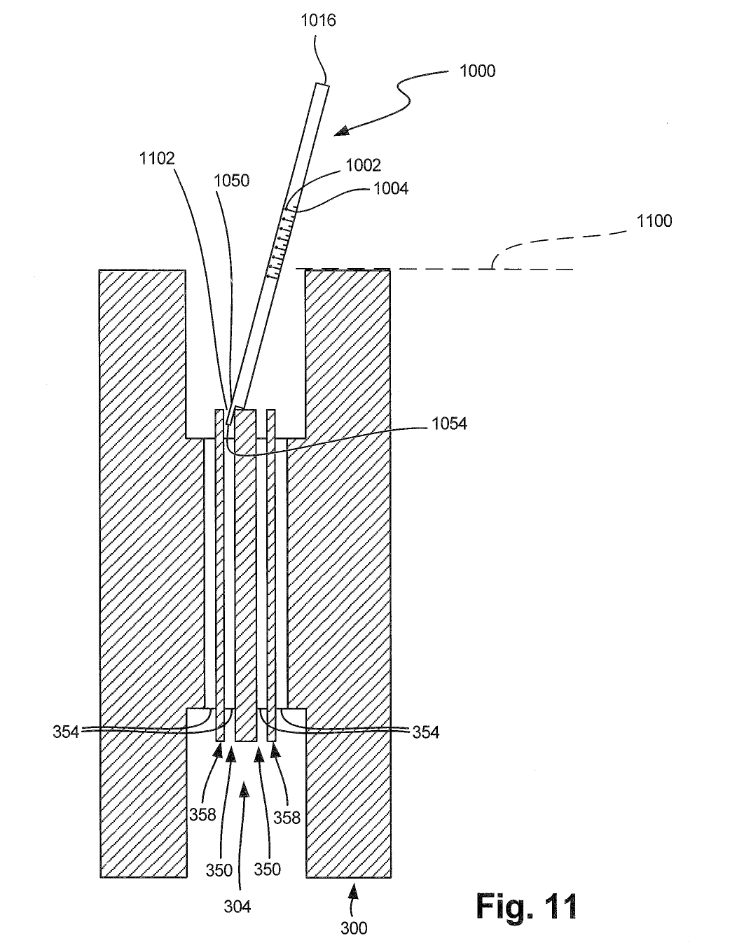

FIG. 10 is a perspective view showing another embodiment 1000 of an orifice plate centering tool which includes gaging markings 1002, 1004, a measurement end 1006 with a radius 1008 and points 1010, and a hole 1014 near end 1016, all similar or identical to components of tool 100. Tool 1000 further includes a lip 1050 attached to or otherwise formed on a side of the tool that is not demarcated with the gaging markings 1002, 1004, and extending from the distal end 1006. Referring also to FIG. 11, the lip 1050 is sized to fit into a gap 1102 between a flange gasket outer ring 358 of a flange gasket 350 and the orifice plate 304, and extends a distance 1052 to tip end 1054 from end 1006. The distance 1052 is small enough that the tip end 1054 of the lip 1050 that extends from the distal end 1006 into the gap 1102 does not exceed the radial distance between the flange gasket sealing surface 354 of flange gasket 350 and the orifice plate 304.

As illustrated in the cross-sectional view of FIG. 11, the lip 1050 is configured to ensure that the distal tip 1006 of the centering tool 1000 is in contact with the orifice plate 304 rather than contacting flange gaskets 350. Without the lip 1050, it may be difficult to determine if the tool 1000 is measuring the position of an orifice plate 304 or of the associated flange gaskets 350. The distal lip 1050 allows the gauge 1000 to be “rocked” towards the upstream flange 300 to thereby obtain an accurate reading at the outer diameter 1100 of the flange as illustrated in FIG. 11. Without this lip 1050, the centering tool 1000 may engage the flange gasket 350 leading to an incorrect reading. With the tip 1050, the distal end 1006 is assured contact with the orifice plate 304 when it is rocked forward, to allow for measurement from the orifice plate 304 as opposed to flange gaskets 350.

Reading measurements of an off-center orifice plate with tool 1000 is otherwise unchanged from reading with tool 100. Further, the alternate embodiments and features of tool 100, such as slider 118 and landings 1200, 1300, and 1400 may also be incorporated into tool 1000 without departing from the scope of the disclosure.

Although the present disclosure has been described with reference to preferred embodiments, workers skilled in the art will recognize that changes may be made in form and detail without departing from the spirit and scope of the disclosure. The centering tool includes at least two tips at the distal end which engage the orifice plate. These tips may be formed based upon a radius as illustrated herein or may be formed in some other manner, for example a step design including a triangular configuration. The tips ensure that the centering tool is centered on the orifice plate so as to present gage markings 100, 102 or 1100, 1102 substantially perpendicular to the orifice plate diameter.

What is claimed is:

1. An orifice plate centering tool for using in centering an orifice plate, comprising:
a thin elongate member;
a distal centering end configured to contact the orifice plate; and
an opposed proximal end configured to receive a force which is transferred to the distal centering end through the elongate member.

2. The orifice plate centering tool of claim 1, wherein the thin elongate member is sufficiently strong to transfer a force applied by a hammer.

3. The orifice plate centering tool of claim 1, wherein the distal contacting end includes at least two points configured to engage the orifice plate.

4. The orifice plate centering tool of claim 3, wherein the at least two points are further configured to engage the orifice plate to maintain the orifice plate centering tool substantially perpendicular to a diameter of the orifice plate.

5. The orifice plate centering tool of claim 1, wherein the distal contacting end comprises a partial radius.

6. The orifice plate centering tool of claim 1, wherein the distal contacting end includes a lip configured to engage the orifice plate.

7. The orifice plate centering tool of claim 1, including a plurality of demarcations positioned along a length of the elongate member.

8. The orifice plate centering tool of claim 7 wherein the plurality of demarcations comprise a plurality of lines and a plurality of numbers, the plurality of lines and the plurality of numbers indicating a distance from the distal end to the plurality of demarcations.

9. The orifice plate centering tool of claim 7, wherein the plurality of demarcations comprise a plurality of ranges indicated with corresponding flange sizes.

10. The orifice plate centering tool of claim 1, and further comprising:
a lip extending from the distal end a distance from the distal end, the lip sized to fit between the orifice plate and a gasket of a flange holding the orifice plate.

11. The orifice plate centering tool of claim 1, and further comprising a measurement component slidably engaging the thin elongate member movably positionable along the thin elongate member, the measurement component configured to display a reading comprising a distance from the distal end to the position of the measurement component.

12. The orifice plate centering tool of claim 1, wherein the distal end further comprises a landing having a cross sectional area larger than a cross section area of the this elongate member.

13. A method of centering an orifice plate using an orifice plate centering tool, comprising:
measuring, along a first axis through a center of the orifice plate, a first distance from a first edge of the orifice plate to a first edge of a flange holding the orifice plate;
measuring a second distance from a second edge of the orifice plate substantially opposite the first edge of the orifice plate to a second edge of the flange substantially opposite the first edge of the flange; and
adjusting the first distance and the second distance to be substantially equal.

14. The method of claim 13, wherein measuring comprises placing two points along a distal centering end of the orifice plate centering tool against a respective edge of the orifice plate, and reading the distance from a plurality of demarcations positioned along a length of the orifice plate centering tool.

15. The method of claim 13, and further comprising:
measuring, along a second axis through the center of the orifice plate substantially perpendicular to the first axis, a third distance from a third edge of the orifice plate to a third edge of a flange holding the orifice plate;
measuring a fourth distance from a fourth edge of the orifice plate substantially opposite the third edge of the orifice plate to a fourth edge of the flange substantially opposite the third edge of the flange; and
adjusting the third distance and the fourth distance to be substantially equal.

16. The method of claim 13, wherein adjusting the first distance and the second distance to be substantially equal comprises moving the orifice plate using the orifice plate centering tool as a punch.

17. The method of claim 13, wherein adjusting the first distance and the second distance to be substantially equal comprises placing the orifice plate centering tool distal centering end in contact with the orifice plate and imparting a force to an opposed proximal end to transfer the force to the distal centering end.

18. The method of claim 15, and further comprising verifying that the first, second third, and fourth distances after adjusting are substantially equal.

19. An orifice plate centering tool for using in centering an orifice plate, comprising:
a thin elongate member;
a distal centering end configured to contact the orifice plate, the distal centering end comprising a concave radius extending from a first edge to a second edge of a width of the elongate member, the concave radius having a first point at an intersection of the first edge and the radius and a second point at an intersection of the second edge and the radius, the first and second points configured to engage the orifice plate to maintain the orifice plate centering tool substantially perpendicular to a diameter of the orifice plate; and
a plurality of demarcations positioned along a length of the elongate member.

20. The orifice plate centering tool of claim 19, and further comprising
a lip extending from the distal end a distance from the distal end, the lip sized to fit between the orifice plate and a gasket of a flange holding the orifice plate.
